(19) United States
(12) Patent Application Publication
(10) Pub. No.: US 2025/0356533 A1
(43) Pub. Date: Nov. 20, 2025

(54) METHOD OF ANALYZING QUANTUM DOT

(71) Applicants: Samsung Display Co., LTD., Yongin-si (KR); Seoul National University R&DB Foundation, Seoul (KR)

(72) Inventors: Junyoung Heo, Yongin-si (KR); Jungwon Park, Seoul (KR); Kihyun Kim, Yongin-si (KR)

(21) Appl. No.: 19/206,535

(22) Filed: May 13, 2025

(30) Foreign Application Priority Data
May 14, 2024 (KR) 10-2024-0063395

(51) Int. Cl. G06T 7/00; G06V 10/762; G06V 10/82

(52) U.S. Cl. CPC G06T 7/97; G06V 10/762; G06V 10/82

(57) ABSTRACT

A method of analyzing a quantum dot includes collecting a plurality of two-dimensional images of a quantum dot, collecting a three-dimensional (“3D”) Coulombic density map by reconstructing a 3D structure of the quantum dot from the plurality of two-dimensional images, collecting an input part from a peak of the 3D Coulombic density map, outputting a first output part by inputting the input part to a feature extraction machine, obtaining a second output part related to a position of the peak by transforming the 3D Coulombic density map into a spherical coordinate system, and analyzing a structure of the quantum dot by first output parts and second output parts obtained from a plurality of peaks of the 3D Coulombic density map.

This application claims priority to Korean Patent Application No. 10-2024-0063395, filed on May 14, 2024, and all the benefits accruing therefrom under 35 U.S.C. § 119, the content of which in its entirety is herein incorporated by reference.

### BACKGROUND

### 1. Field

Embodiments relate to a method of analyzing a quantum dot.

### 2. Description of the Related Art

Display apparatuses visually display data. Display apparatuses may display images by light-emitting diodes. The purposes of display apparatuses are being diversified, and various methods of analyzing display apparatuses are being attempted to improve the quality of display apparatuses.

### SUMMARY

Embodiments include a method of analyzing a quantum dot.

Additional features will be set forth in part in the description which follows and, in part, will be apparent from the description, or may be learned by practice of the presented embodiments of the disclosure.

In an embodiment of the disclosure, a method of analyzing a quantum dot includes collecting a plurality of two-dimensional (“2D”) images of a quantum dot, collecting a three-dimensional (“3D”) Coulombic density map by reconstructing a 3D structure of the quantum dot from the plurality of 2D images, collecting an input part from a peak of the 3D Coulombic density map, outputting a first output part by inputting the input part to a feature extraction machine, obtaining a second output part related to a position of the peak by transforming the 3D Coulombic density map into a spherical coordinate system, and analyzing a structure of the quantum dot from first output parts and second output parts obtained from a plurality of peaks of the 3D Coulombic density map.

In an embodiment, the input part may be a 7×7×7 voxel obtained from a center of the peak of the 3D Coulombic density map.

In an embodiment, the feature extraction machine may include a convolutional neural network (“CNN”).

In an embodiment, the feature extraction machine may include a convolution layer, a flatten layer, and fully connected layers.

In an embodiment, the feature extraction machine may sequentially include three convolution layers, one flatten layer, and three fully connected layers.

In an embodiment, the first output part may be output before a fully connected layer that is disposed last among the three fully connected layer.

In an embodiment, the first output part may be a feature vector at the position of the peak of the 3D Coulombic density map.

In an embodiment, the feature vector may include ten numbers.

In an embodiment, the second output part may be a position vector of the peak of the 3D Coulombic density map in a transformed spherical coordinate system transformed from the spherical coordinate system.

In an embodiment, the position vector may include three numbers.

In an embodiment, the analyzing the structure of the quantum dot by the first output parts and the second output parts obtained from the plurality of peaks of the 3D Coulombic density map may include classifying the first output parts and the second output parts into a plurality of groups by K-means clustering of the first output parts and the second output parts obtained from the plurality of peaks of the 3D Coulombic density map.

In an embodiment, the structure of the quantum dot may be analyzed by matching the plurality of groups to a predetermined atom.

In an embodiment, the method may further include obtaining, from the 3D coulombic density map, an interface between a core and a shell of the quantum dot and a shape of the quantum dot.

In an embodiment, the method may further include training the feature extraction machine.

In an embodiment of the disclosure, a method of analyzing a quantum dot includes collecting a plurality of two-dimensional images of the quantum dot, collecting a 3D coulombic density map by reconstructing a 3D structure of the quantum dot from the plurality of 2D images, collecting an input part from a peak of the 3D Coulombic density map, outputting a feature vector by inputting the input part to a feature extraction machine, obtaining a position vector related to a position of the peak by transforming the 3D Coulombic density map into a spherical coordinate system, and analyzing a structure of the quantum dot from feature vectors and position vectors obtained from a plurality of peaks of the 3D Coulombic density map.

In an embodiment, the input part may be a 7×7×7 voxel obtained from a center of the peak of the 3D Coulombic density map.

In an embodiment, the feature extraction machine may include a CNN.

In an embodiment, the feature extraction machine may sequentially include three convolution layers, one flatten layer, and three fully connected layers.

In an embodiment, the analyzing the structure of the quantum dot by the feature vectors and the position vectors obtained from the plurality of peaks of the 3D Coulombic density map may include classifying the feature vectors and the position vectors into a plurality of groups by K-means clustering of the feature vectors and the position vectors obtained from the plurality of peaks.

In an embodiment, the structure of the quantum dot may be analyzed by matching the plurality of groups to a predetermined atom.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a schematic perspective view of an embodiment of a display apparatus;

FIG. 2 is a schematic cross-sectional view of an embodiment of respective pixels of a display apparatus;

FIG. 3 is a schematic view of respective optical portions of a color conversion-transmissive layer of FIG. 2;

FIG. 4 is an equivalent circuit diagram of an embodiment of a light-emitting diode and a pixel circuit electrically connected to the light-emitting diode of a display apparatus;

FIG. 5 is a schematic flowchart showing an embodiment of a method of analyzing a quantum dot by a feature extraction machine;

FIG. 6 is a schematic block diagram of layers included in a feature extraction machine;

FIG. 7 is a schematic view showing a process of classifying first output parts and second output parts into a plurality of groups by K-means clustering of the first output parts and second output parts;

FIGS. 8 and 9 are schematic views showing operations of training a feature extraction machine; and

FIG. 10 is a schematic flowchart showing a method of analyzing a quantum dot.

### DETAILED DESCRIPTION

Reference will now be made in detail to embodiments, illustrated embodiments of which are illustrated in the accompanying drawings, where like reference numerals refer to like elements throughout. In this regard, the illustrated embodiments may have different forms and should not be construed as being limited to the descriptions set forth herein. Accordingly, the embodiments are merely described below, by referring to the drawing figures, to explain features of the description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, illustrative embodiments will be illustrated in the drawings and described in the written description. Effects and features of the disclosure, and methods for achieving them will be clarified with reference to embodiments described below in detail with reference to the drawings. However, the disclosure is not limited to the following embodiments and may be embodied in various forms.

Hereinafter, embodiments will be described with reference to the accompanying drawings, wherein like reference numerals refer to like elements throughout and a repeated description thereof is omitted.

While such terms as “first” and “second” may be used to describe various elements, such elements must not be limited to the above terms. The above terms are used to distinguish one element from another.

The singular forms “a,” “an,” and “the” as used herein are intended to include the plural forms as well unless the context clearly indicates otherwise.

It will be understood that the terms “comprise,” “comprising,” “include” and/or “including” as used herein specify the presence of stated features or elements but do not preclude the addition of one or more other features or elements.

It will be further understood that, when a layer, region, or element is referred to as being “on” another layer, region, or element, it may be directly or indirectly on the other layer, region, or element. That is, for example, intervening layers, regions, or elements may be present.

Sizes of elements in the drawings may be exaggerated or reduced for convenience of explanation. As an example, the size and thickness of each element shown in the drawings are arbitrarily represented for convenience of description, and thus, the disclosure is not necessarily limited thereto.

In the case where an illustrative embodiment may be implemented differently, a specific process order may be performed in the order different from the described order. As an example, two processes successively described may be simultaneously performed substantially and performed in the opposite order.

In the specification, “A and/or B” means A or B, or A and B. In the specification, “at least one of A and B” means A or B, or A and B.

It will be understood that when a layer, region, or element is referred to as being “connected” to another layer, region, or element, it may be “directly connected” to the other layer, region, or element or may be “indirectly connected” to the other layer, region, or element with another layer, region, or element located therebetween. For example, it will be understood that when a layer, region, or element is referred to as being “electrically connected” to another layer, region, or element, it may be “directly electrically connected” to the other layer, region, or element or may be “indirectly electrically connected” to the other layer, region, or element with another layer, region, or element interposed therebetween.

The x-axis, the y-axis and the z-axis are not limited to three axes of the rectangular coordinate system, and may be interpreted in a broader sense. For example, the x-axis, the y-axis, and the z-axis may be perpendicular to one another, or may represent different orientations that are not perpendicular to one another.

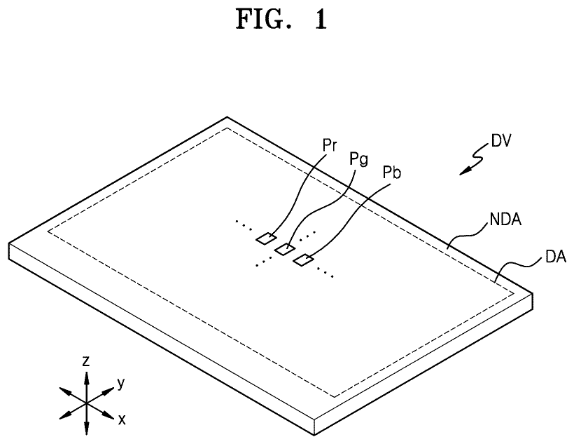

FIG. 1 is a schematic perspective view of an embodiment of a display apparatus DV.

Referring to FIG. 1, the display apparatus DV may include a display area DA, and a non-display area NDA outside the display area DA. The display apparatus DV may display images through an array of a plurality of pixels arranged two-dimensionally in an x-y plane in the display area DA. The plurality of pixels include a first pixel, a second pixel, and a third pixel. Hereinafter, for convenience of description, the case where the first pixel is a red pixel Pr, the second pixel is a green pixel Pg, and the third pixel is a blue pixel Pb is described.

The red pixel Pr, the green pixel Pg, and the blue pixel Pb are regions that respectively emit red, green, and blue light. The display apparatus DV may display images by light emitted from the pixels.

The non-display area NDA is a region that is configured not to display images and may surround the display area DA entirely. A driver or a main voltage line which provides electrical signals or power to pixel circuits may be arranged in the non-display area NDA. A pad may be disposed in the non-display area NDA, and the pad is a region to which electronic elements or a printed circuit board may be electrically connected.

As shown in FIG. 1, the display area DA may have a polygonal shape including a quadrangular shape. In an embodiment, the display area DA may have a quadrangular shape, e.g., a rectangular shape in which a horizontal length thereof is greater than a vertical length, a quadrangular shape, e.g., a rectangular shape in which a horizontal length thereof is less than a vertical length, or a square shape. In an alternative embodiment, the display area DA may have various shapes such as an elliptical shape or a circular shape.

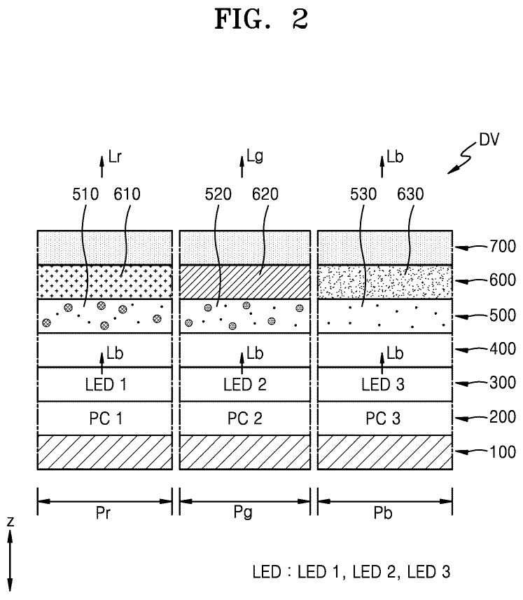

FIG. 2 is a schematic cross-sectional view of an embodiment of respective pixels of the display apparatus DV.

Referring to FIG. 2, the display apparatus DV may include a circuit layer 200 on a substrate 100. The circuit layer 200 may include first to third pixel circuits PC1, PC2, and PC3. The first to third pixel circuits PC1, PC2, and PC3 may be respectively and electrically connected to first to third light-emitting diodes LED1, LED2, and LED3 of a light-emitting diode layer 300.

The first to third light-emitting diodes LED1, LED2, and LED3 may each include an organic light-emitting diode including an organic material. In another embodiment, the first to third light-emitting diodes LED1, LED2, and LED3 may each include an inorganic light-emitting diode including an inorganic material. The inorganic light-emitting diode may include a PN-junction diode including inorganic material semiconductor-based materials. When a forward voltage is applied to a PN-junction diode, holes and electrons are injected and energy created by recombination of the holes and the electrons is converted to light energy, and thus, light of a preset color may be emitted. The inorganic light-emitting diode may have a width of several micrometers to hundreds of micrometers, or several nanometers to hundreds of nanometers. In an embodiment, a light-emitting diode LED may be a light-emitting diode including quantum dots. As described above, an emission layer of the light-emitting diode LED may include an organic material, an inorganic material, quantum dots, an organic material and quantum dots, or inorganic material and quantum dots.

The first to third light-emitting diodes LED1, LED2, and LED3 may emit light of the same color. In an embodiment, light (e.g., blue light Lb) emitted from the first to third light-emitting diodes LED1, LED2, and LED3 may pass through a color conversion-transmissive layer 500 through an encapsulation layer 400 on the light-emitting diode layer 300.

The color conversion-transmissive layer 500 may include optical portions which convert the color of light (e.g., blue light Lb) emitted from the light-emitting diode layer 300, or transmit the light without converting the color. In an embodiment, the color conversion-transmissive layer 500 may include color converters and a transmitter, and the color converters convert light (e.g., blue light Lb) emitted from the light-emitting diode layer 300 to light of a different color, and the transmitter transmits light (e.g., blue light Lb) emitted from the light-emitting diode layer 300 without converting a color thereof. The color conversion-transmissive layer 500 may include a first color-converter 510 corresponding to the red pixel Pr, a second color-converter 520 corresponding to the green pixel Pg, and a transmitter 530 corresponding to the blue pixel Pb. The first color-converter 510 may convert blue light Lb into red light Lr, and the second color-converter 520 may convert blue light Lb into green light Lg. The transmitter 530 may transmit blue light Lb without converting the blue light Lb.

A color layer 600 may be disposed on the color conversion-transmissive layer 500. The color layer 600 may include first to third color filters 610, 620, and 630 of different colors. In an embodiment, the first color filter 610 may be a red color filter, the second color filter 620 may be a green color filter, and the third color filter 630 may be a blue color filter.

Light that is color-converted or transmitted by the color conversion-transmissive layer 500 may be improved in color purity thereof while respectively passing through the first to third color filters 610, 620, and 630. In addition, the color layer 600 may prevent or reduce external light (e.g., light incident to the display apparatus DV from the outside of the display apparatus DV) from being reflected and viewed by a user.

A light-transmissive base layer 700 may be provided to the color layer 600. The light-transmissive base layer 700 may include glass or a light-transmissive organic material. In an embodiment, the light-transmissive base layer 700 may include a light-transmissive organic material such as an acryl-based resin.

In an embodiment, the light-transmissive base layer 700 is a kind of substrate. The color layer 600 and color conversion-transmissive layer 500 are formed on the light-transmissive base layer 700, and then the color conversion-transmissive layer 500 may be integrated to face the encapsulation layer 400.

In another embodiment, after the color conversion-transmissive layer 500 and the color layer 600 are sequentially formed on the encapsulation layer 400, the light-transmissive base layer 700 may be directly coated and cured on the color layer 600. In an embodiment, another optical film, e.g., an anti-reflection (“AR”) film or the like, may be disposed on the light-transmissive base layer 700.

The display apparatus DV having the above structure may include electronic apparatuses that may display moving images or still images such as televisions, advertisement boards, screens for a theater, monitors, tablet personal computers, or the like.

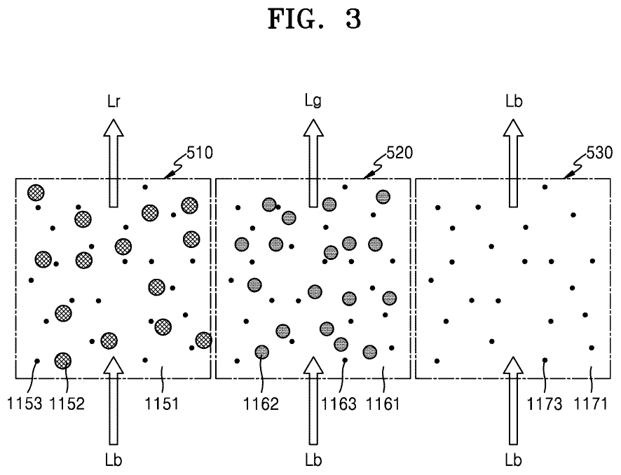

FIG. 3 is a schematic view of respective optical portions of the color conversion-transmissive layer 500 of FIG. 2.

Referring to FIG. 3, the first color-converter 510 may convert blue light Lb incident thereto into red light Lr. As shown in FIG. 3, the first color-converter 510 may include a first photosensitive polymer 1151, first quantum dots 1152, and first scattering particles 1153 dispersed in the first photosensitive polymer 1151.

The first quantum dots 1152 may be excited by blue light Lb and may isotropically emit red light Lr having a greater wavelength than the wavelength of the blue light Lb. The first photosensitive polymer 1151 may be an organic material having light transmittance. The first scattering particles 1153 may increase a color-converting efficiency by scattering blue light Lb not absorbed in the first quantum dots 1152 and allowing more first quantum dots 1152 to be excited. The first scattering particles 1153 may be titanium oxide (TiO₂), metal particles, or the like, for example. The first quantum dots 1152 may be one of a Group II-Group VI compound, a Group III-Group V compound, a Group IV-Group VI compound, a Group IV compound, a Group IV compound, or any combinations thereof.

The second color converter 520 may convert blue light Lb incident thereto to green light Lg. As shown in FIG. 3, the second color converter 520 may include a second photosensitive polymer 1161, second quantum dots 1162, and second scattering particles 1163 dispersed in the second photosensitive polymer 1161.

The second quantum dots 1162 may be excited by blue light Lb and may isotropically emit green light Lg having a greater wavelength than the wavelength of the blue light Lb. The second photosensitive polymer 1161 may be an organic material having light transmittance.

The second scattering particles 1163 may increase a color-converting efficiency by scattering blue light Lb not absorbed in the second quantum dots 1162 and allowing more second quantum dots 1162 to be excited. The second scattering particles 1163 may be titanium oxide (TiO₂), metal particles, or the like, for example. The second quantum dots 1162 may be one of a Group II-Group VI compound, a Group III-Group V compound, a Group IV-Group VI compound, a Group IV compound, a Group IV compound, or any combinations thereof.

The transmitter 530 may transmit blue light Lb without converting the blue light Lb incident to the transmitter 530. As shown in FIG. 3, the transmitter 530 may include a third photosensitive polymer 1171 in which third scattering particles 1173 are dispersed. The third photosensitive polymer 1171 may include an organic material having a light transmittance such as a silicon resin, epoxy resin, or the like, for example, and include the same material as the material of the first photosensitive polymer 1151 and the second photosensitive polymer 1161. The third scattering particles 1173 may scatter and emit blue light Lb and include the same material as those of the first and second scattering particles 1153 and 1163.

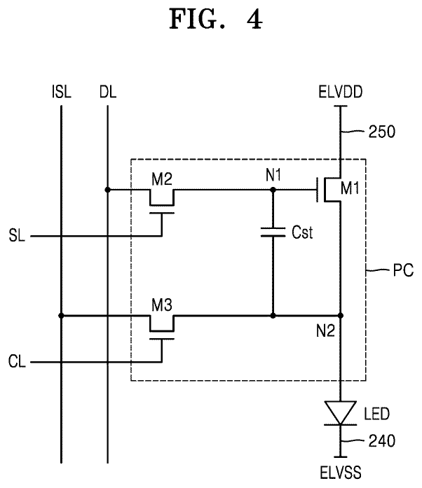

FIG. 4 is an equivalent circuit diagram of an embodiment of a light-emitting diode and a pixel circuit electrically connected to the light-emitting diode of the display apparatus. The pixel circuit PC shown in FIG. 4 may correspond to each of the first to third pixel circuits PC1, PC2, and PC3 described above with reference to FIG. 2, and the light-emitting diode LED of FIG. 4 may correspond to each of the first to third light-emitting diodes LED1, LED2, and LED3 described above with reference to FIG. 2.

Referring to FIG. 4, a light-emitting diode, e.g., a pixel electrode (e.g., an anode) of the light-emitting diode LED, may be connected to the pixel circuit PC, and an opposite electrode (e.g., a cathode) of the light-emitting diode LED may be connected to an auxiliary line 240 which provides a common voltage ELVSS. The light-emitting diode LED may emit light at a brightness corresponding to the amount of current supplied from the pixel circuit PC.

The light-emitting diode LED of FIG. 4 may correspond to each of the first to third light-emitting diodes LED1, LED2, and LED3 shown above in FIG. 2. The pixel circuit PC of FIG. 4 may correspond to each of the first to third pixel circuits PC1, PC2, and PC3 shown above in FIG. 2.

The pixel circuit PC may control the amount of current flowing from a driving voltage ELVDD to the common voltage ELVSS through the light-emitting diode LED according to a data signal. The pixel circuit PC may include a first transistor M1, a second transistor M2, a third transistor M3, and a storage capacitor Cst.

Each of the first transistor M1, the second transistor M2, and the third transistor M3 may be an oxide semiconductor transistor including a semiconductor layer that includes an oxide semiconductor, or may be a silicon semiconductor transistor including a semiconductor that includes polycrystalline silicon. A first electrode may be one of a source electrode and a drain electrode, and a second electrode may be the other of a source electrode and a drain electrode depending on the type of a transistor.

One electrode of the first transistor M1 may be connected to a driving voltage line 250 which supplies the driving voltage ELVDD, and another electrode of the first transistor M1 may be connected to a pixel electrode of the light-emitting diode LED. A gate electrode of the transistor M1 may be connected to a first node N1. The first transistor M1 may control the amount of current flowing from the driving voltage ELVDD to the light-emitting diode LED in response to a voltage of the first node N1.

The second transistor M2 may be a switching transistor. One electrode of the second transistor M2 may be connected to the data line DL, and another electrode of the second transistor M2 may be connected to the first node N1. A gate electrode of the second transistor M2 may be connected to a scan line SL. When a scan signal is supplied through the scan line SL, the second transistor M2 may be turned on to electrically connect the data line DL to the first node N1.

The third transistor M3 may be an initialization transistor and/or a sensing transistor. One electrode of the third transistor M3 may be connected to a second node N2, and another electrode of the third transistor M3 may be connected to a sensing line ISL. A gate electrode of the third transistor M3 may be connected to a control line CL.

The storage capacitor Cst may be connected between the first node N1 and the second node N2. In an embodiment, a first capacitor electrode of the storage capacitor Cst may be connected to the gate electrode of the first transistor M1, and a second capacitor electrode of the storage capacitor Cst may be connected to the pixel electrode of the light-emitting diode LED.

Although it is shown in FIG. 4 that the first transistor M1, the second transistor M2, and the third transistor M3 are n-channel metal oxide semiconductor (“MOS”) field-effect transistors (“FETs”), the disclosure is not limited thereto. In an embodiment, at least one of the first transistor M1, the second transistor M2, and the third transistor M3 may be a p-channel MOSFETs.

Although FIG. 4 shows three transistors, the disclosure is not limited thereto. The pixel circuit PC may include four or more transistors.

Then, at least one of the driving transistor M1, the switching transistor M2, and the sensing transistor M3 may be manufactured during a process described below.

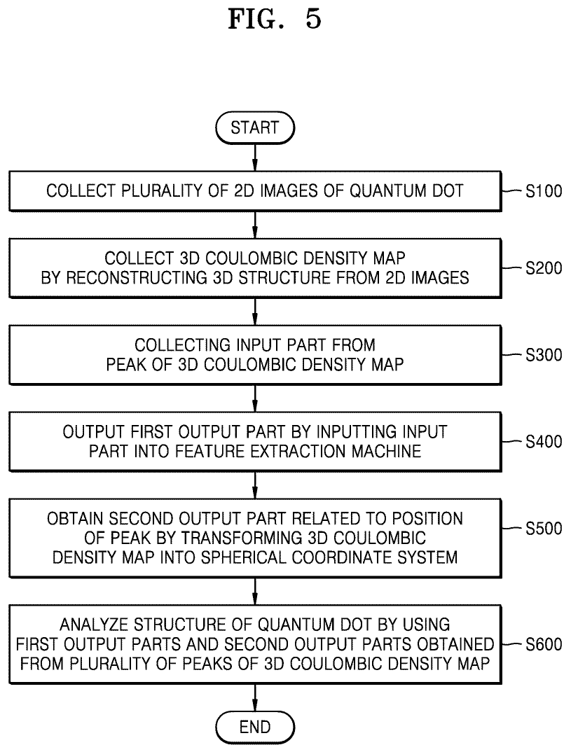

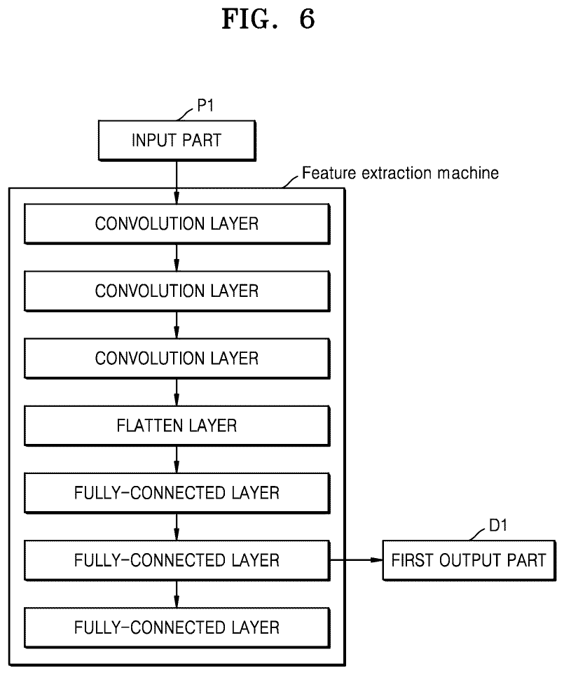

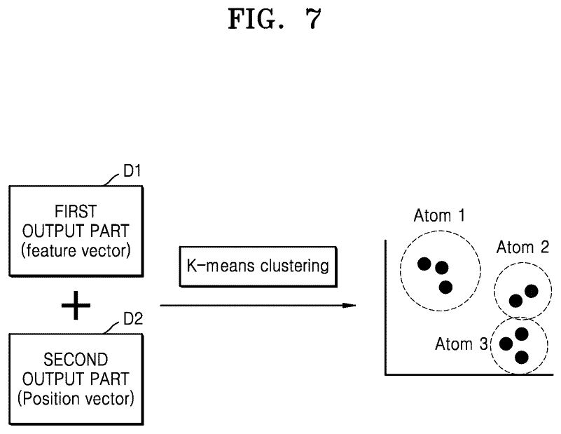

FIG. 5 is a schematic flowchart showing an embodiment of a method of analyzing a quantum dot using a feature extraction machine. FIG. 6 is a schematic block diagram of layers included in the feature extraction machine. FIG. 7 is a schematic view showing a process of classifying first output parts and second output parts into a plurality of groups by K-means clustering the first output parts and second output parts.

Referring to FIG. 5, a method of analyzing quantum dots may include collecting a plurality of two-dimensional (“2D”) images of a quantum dot (S100), collecting a three-dimensional (“3D”) Coulombic density map by reconstructing a 3D structure of the quantum dot from the plurality of 2D images (S200), collecting an input part P1 (refer to FIG. 6) from a peak of the 3D Coulombic density map (S300), outputting a first output part D1 (refer to FIG. 6) by inputting the input part P1 to a feature extraction machine (S400), obtaining a second output part D2 (refer to FIG. 7) related to a position of the peak by transforming the 3D Coulombic density map to a spherical coordinate system (S500), and analyzing a structure of the quantum dot by first output parts D1 and second output parts D2 obtained from a plurality of peaks of the 3D Coulombic density map (S600). This is described in more detail. In an embodiment the operations S100 to S600 may be performed by a controlling circuitry such as a processor, but the disclosure is not limited thereto.

In the collecting of the plurality of 2D images of the quantum dot (S100), the quantum dot may be manufactured in the form of a liquid cell. A liquid cell may be a form in which a quantum dot is dissolved in liquid and then encapsulated with graphene or silicon oxide (SiOₓ). 2D images of the quantum dot may be collected by capturing the liquid cell including or consisting of the quantum dot using a transmission electron microscope (“TEM”). 2D images of the quantum dot may be obtained from various directions for successful 3D structural analysis. However, the disclosure is not limited thereto.

In the collecting of the 3D Coulombic density map by reconstructing the 3D structure of the quantum dot from the plurality of 2D images (S200), the 3D structure of the quantum dot may be reconstructed and the 3D Coulombic density map may be collected through repetition of projection direction allocation and 3D structure volume assembly. To reconstruct the 3D structure of the quantum dot, an initial 3D model is specified from a lattice structure of materials included in the quantum dot, and then 2D images that capture the initial 3D model in various directions may be obtained. The direction from which each of the 2D images of the quantum dot is captured may be specified by comparing the 2D images collected from the quantum dot with the 2D images collected from the initial 3D model. Based on this, the 3D structure of the quantum dot may be reconstructed and the 3D Coulombic density map may be collected.

Referring to FIGS. 5 and 6, the collecting of the input part P1 from the peak of the 3D Coulombic density map (S300) may include obtaining a 7×7×7 voxel from the center of the peak of the 3D Coulombic density map. In other words, the input part P1 may be a 7×7×7 voxel obtained from the center of the peak of the 3D Coulombic density map.

In the outputting of the first output part D1 by inputting the input part P1 obtained from the center of the peak of the 3D Coulombic density map to the feature extraction machine (S400), the feature extraction machine may include a convolution neural network (“CNN”). The CNN may be a kind of a deep neural network (“DNN”) which is an artificial neural network including a plurality of hidden layers between an input layer and an output layer. The feature extraction machine including the CNN may be used to extract feature vectors that distinguish the kind of atoms and may include a plurality of layers. Each of the layers may receive input data and process the input data of the relevant layer to generate output data. The feature extraction machine may include a convolution layer, a flatten layer, and a fully connected layer. Specifically, the feature extraction machine may sequentially include three convolution layers, one flatten layer, and three fully connected layers. The input part which is input to the feature extraction machine and which is a 7×7×7 voxel obtained from the center of the peak of the 3D Coulombic density map may be converted through convolutional operations while undergoing three convolution layers, and converted to one dimension while undergoing one flatten layer. Next, input data may be processed using a neural network structure while undergoing three fully connected layers. The first output part D1 may be obtained before a fully connected layer disposed last, and may be a feature vector including ten numbers.

Referring to FIGS. 5 to 7, in the obtaining of the second output part D2 related to a position of the peak by transforming the 3D Coulombic density map to the spherical coordinate system (S500), the second output part D2 may be a position vector of the peak of the 3D Coulombic density map in the transformed spherical coordinate system.

In the analyzing of the structure of the quantum dot by the first output parts D1 and the second output parts D2 obtained from the plurality of peaks of the 3D Coulombic density map (S600), the first output parts D1 and the second output parts D2 obtained from the plurality of peaks of the 3D Coulombic density map may be classified into a plurality of groups by K-means clustering the first output parts D1 and the second output parts D2. The plurality of peaks of the 3D Coulombic density map may be matched to a predetermined atom by matching the plurality of groups to a predetermined atom, and as a result, the structure of an atom included in the quantum dot may be analyzed and the kind of the atom may be determined. In the process of matching the plurality of groups to a predetermined atom, dictionary information about the kind of atom included in the quantum dot may be used.

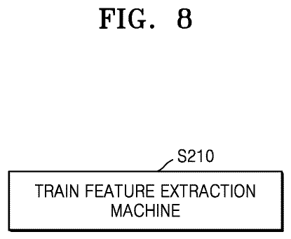

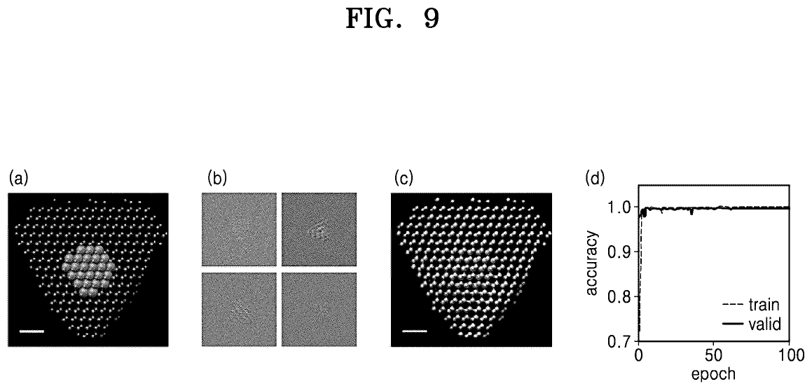

FIGS. 8 and 9 are schematic views showing operations of training the feature extraction machine. The method of analyzing a quantum dot may further include training the feature extraction machine (S210). The training of the feature extraction machine (S210) may include preparing a quantum dot model having an indium phosphorous (InP) spherical core and zinc selenium (ZnSe) tetrahedral shell in an embodiment. In FIG. 9, (a) schematically shows an atomic structure of a quantum dot model with an indium phosphorous (InP) spherical core and a zinc selenium (ZnSe) tetrahedral shell. A liquid cell including a quantum dot with an indium phosphorous (InP) spherical core and a zinc selenium (ZnSe) tetrahedral shell is manufactured, and then, a plurality of 2D images captured in various directions using TEM may be obtained. In FIG. 9, (b) shows 2D simulation images of a quantum dot with an InP spherical core and a ZnSe tetrahedral shell, obtained through TEM. A 3D structure of the quantum dot may be reconstructed and the 3D Coulombic density map of the quantum dot with InP spherical core and a ZnSe tetrahedral shell may be collected through repetition of the projection direction allocation and the 3D structure volume assembly of the 2D images of the quantum dot with InP spherical core and a ZnSe tetrahedral shell. In FIG. 9, (c) schematically shows the 3D Coulombic density map of a quantum dot model with an InP spherical core and a ZnSe tetrahedral shell. As a result of training the feature extraction machine using the 3D Coulombic density map of a quantum dot model with an InP spherical core and a ZnSe tetrahedral shell, the accuracy of the atom distinction may converge to about 100%. In FIG. 9, (d) is a graph showing the accuracy of the atom distinction of the feature extraction machine converges to about 100% as a result of training the feature extraction machine.

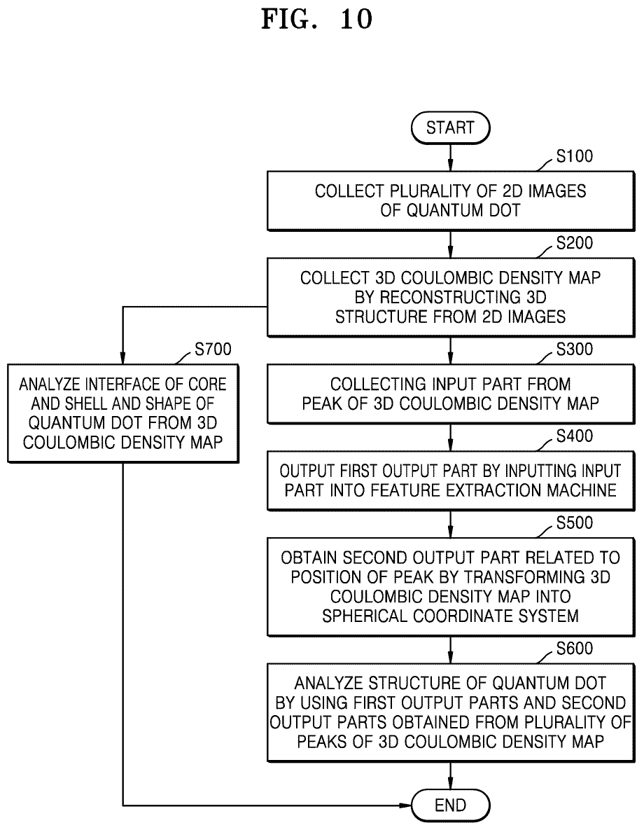

FIG. 10 is a schematic flowchart showing the method of analyzing a quantum dot. Referring to FIG. 10, the method of analyzing the quantum dot may further include obtaining an interface between the core and the shell, and a shape of the quantum dot from the 3D Coulombic density map (S700). In an embodiment the operation S700 may be performed by a controlling circuitry such as a processor, but the disclosure is not limited thereto.

The structure of a quantum dot having a diameter of 12 nanometers (nm) or less may be analyzed through the method of analyzing the quantum dot in an embodiment. When the diameter of a quantum dot exceeds 12 nm, the difficulty of reconstructing the 3D structure of the quantum dot increases, making it difficult to secure data, and there may be difficulties in analyzing the structure of a quantum dot through the method of analyzing the quantum dot in an embodiment.

The structure of a quantum dot may be analyzed by K-means clustering position vectors of peaks that are obtained by transforming the 3D Coulombic density map of quantum dots to the spherical coordinate system, classifying the position vectors into a plurality of groups, and matching the plurality of groups to a predetermined atom.

In an embodiment having the above configuration, the method of analyzing the display apparatus with improved quality and accuracy may be implemented. However, the scope of the disclosure is not limited by this effect.

It should be understood that embodiments described herein should be considered in a descriptive sense only and not for purposes of limitation. Descriptions of features or advantages within each embodiment should typically be considered as available for other similar features or advantages in other embodiments. While embodiments have been described with reference to the drawing figures, it will be understood by those of ordinary skill in the art that various changes in form and details may be made therein without departing from the spirit and scope as defined by the following claims.

What is claimed is:

1. A method of analyzing a quantum dot, the method comprising:
collecting a plurality of two-dimensional images of the quantum dot;
collecting a three-dimensional Coulombic density map by reconstructing a three-dimensional structure of the quantum dot from the plurality of two-dimensional images;
collecting an input part from a peak of the three-dimensional Coulombic density map;
outputting a first output part by inputting the input part to a feature extraction machine;
transforming the three-dimensional Coulombic density map into a spherical coordinate system and obtaining a second output part related to a position of the peak by the transforming; and
analyzing a structure of the quantum dot from first output parts and second output parts obtained from a plurality of peaks of the three-dimensional Coulombic density map.

2. The method of claim 1, wherein the input part is a 7×7×7 voxel obtained from a center of the peak of the three-dimensional Coulombic density map.

3. The method of claim 1, wherein the feature extraction machine includes a convolutional neural network.

4. The method of claim 3, wherein the feature extraction machine includes a convolution layer, a flatten layer, and fully connected layers.

5. The method of claim 4, wherein the feature extraction machine sequentially includes three convolution layers, one flatten layer, and three fully connected layers.

6. The method of claim 5, wherein the first output part is output before a fully connected layer which is disposed last among the three fully connected layer.

7. The method of claim 1, wherein the first output part is a feature vector at the position of the peak of the three-dimensional Coulombic density map.

8. The method of claim 7, wherein the feature vector includes ten numbers.

9. The method of claim 1, wherein the second output part is a position vector of the peak of the three-dimensional Coulombic density map in a transformed spherical coordinate system transformed from the spherical coordinate system.

10. The method of claim 9, wherein the position vector includes three numbers.

11. The method of claim 1, wherein the analyzing the structure of the quantum dot by the first output parts and the second output parts obtained from the plurality of peaks of the three-dimensional Coulombic density map includes classifying the first output parts and the second output parts into a plurality of groups by K-means clustering of the first output parts and the second output parts obtained from the plurality of peaks of the three-dimensional Coulombic density map.

12. The method of claim 11, wherein the structure of the quantum dot is analyzed by matching the plurality of groups to a predetermined atom.

13. The method of claim 1, further comprising obtaining, from the three-dimensional Coulombic density map, an interface between a core and a shell of the quantum dot and a shape of the quantum dot.

14. The method of claim 1, further comprising training the feature extraction machine.

15. A method of analyzing a quantum dot, the method comprising:
collecting a plurality of two-dimensional images of the quantum dot;
collecting a three-dimensional Coulombic density map by reconstructing a three dimensional structure of the quantum dot from the plurality of two-dimensional images;
collecting an input part from a peak of the three-dimensional Coulombic density map;
outputting a feature vector by inputting the input part to a feature extraction machine;
transforming the three-dimensional Coulombic density map into a spherical coordinate system and obtaining a position vector related to a position of the peak by the transforming; and
analyzing a structure of the quantum dot from feature vectors and position vectors obtained from a plurality of peaks of the three-dimensional Coulombic density map.

16. The method of claim 15, wherein the input part is a 7×7×7 voxel obtained from a center of the peak of the three-dimensional Coulombic density map.

17. The method of claim 15, wherein the feature extraction machine includes a convolutional neural network.

18. The method of claim 17, wherein the feature extraction machine sequentially includes three convolution layers, one flatten layer, and three fully connected layers.

19. The method of claim 15, wherein the analyzing the structure of the quantum dot by the feature vectors and the position vectors obtained from the plurality of peaks of the three-dimensional Coulombic density map includes classifying the feature vectors and the position vectors into a plurality of groups by K-means clustering of the feature vectors and the position vectors obtained from the plurality of peaks.

20. The method of claim 19, wherein the structure of the quantum dot is analyzed by matching the plurality of groups to a predetermined atom.
